(19) United States
(12) Patent Application Publication
(10) Pub. No.: US 2008/0033812 A1
(43) Pub. Date: Feb. 7, 2008

(54) System for highlighting a dynamic personalized object placed in a multi-media program

(75) Inventors: Daniel B. McKenna, Vail, CO (US); James M. Graziano, Hotchkiss, CO (US)

Correspondence Address: PATTON BOGGS LLP, 1801 CALFORNIA STREET, SUITE 4900, DENVER, CO, 80202, US

(73) Assignee: Vulano Group, Inc., Vail, CO (US)

(21) Appl. No.: 11/581,632

(22) Filed: Oct. 16, 2006

Related U.S. Application Data
(63) Continuation-in-part of application No. 11/486,923, filed on Jul. 14, 2006.
Application No. 11/486,923 is a continuation-in-part of application No. 11/487,024, filed on Jul. 14, 2006.
Application No. 11/487,024 is a continuation-in-part of application No. 11/487,070, filed on Jul. 14, 2006.
Application No. 11/487,070 is a continuation-in-part of application No. 11/486,900, filed on Jul. 14, 2006.
Application No. 11/486,900 is a continuation-in-part of application No. 11/486,922, filed on Jul. 14, 2006.
Application No. 11/486,922 is a continuation-in-part of application No. 11/486,862, filed on Jul. 14, 2006.
Application No. 11/486,862 is a continuation-in-part of application No. 11/486,683, filed on Jul. 14, 2006.
Application No. 11/486,683 is a continuation-in-part of application No. 11/487,065, filed on Jul. 14, 2006.

(51) Int. Cl. G06Q 30/00

(52) U.S. Cl. 705/14

(57) ABSTRACT

The present System For Highlighting A Dynamic Personalized Object Placed In A Multi-Media Program functions to manage the delivery of Object (product) placements in a Multi-Media Program. The multi-media object highlighting system controls the retrieval of Object data that comprises a product representation and the integration of this Object data into a corresponding selected one of the predetermined Multi-Media Object Locations which are components of the Multi-Media Program. In addition, the multi-media object highlighting system produces a representation of the object that highlights the object in the scenes in which it appears. The highlighting can be any human sensible characteristic, such as, but not limited to: flashing, changes in brightness, movement, change in representation, and the like. The highlighting can also include the use of an anomaly, such as a color representation in a black and white multi-media program or vice versa, or out-of-context object.

### CROSS-REFERENCE TO RELATED APPLICATIONS

This application is continuation-in-part of application Ser. No. 11/486,923 filed Jul. 14, 2006 and titled “System For Dynamic Personalized Object Placement In A Multi-Media Program; and application Ser. No. 11/487,024 filed Jul. 14, 2006 and titled “System For Managing The Purchasing Of Dynamic Personalized Object Placement In A Multi-Media Program”; and application Ser. No. 11/487,070 filed Jul. 14, 2006 and titled “Network Architecture For Dynamic Personalized Object Placement In A Multi-Media Program”; and application Ser. No. 11/486,900 filed Jul. 14, 2006 and titled “System For Dynamic Recipient-Specific Object Placement In A Multi-Media Program”, and application Ser. No. 11/486,922 filed Jul. 14, 2006 and titled “System For Product Placement Rendering In A Multi-Media Program”; and application Ser. No. 11/486,862 filed Jul. 14, 2006 and titled “System For Dynamic Logical Control Of Personalized Object Placement In A Multi-Media Program”; and application Ser. No. 11/486,683 filed Jul. 14, 2006 and titled “System For Creating Dynamic Personalized Object Placement Media”; and application Ser. No. 11/487,065 filed Jul. 14, 2006 and titled: Digital Rights Management In Dynamic Personalized Object Placement In A Multi-Media Program”.

### FIELD OF THE INVENTION

The present invention relates to the field of Multi-Media Programs that are delivered to recipients and to a system that enables the dynamic placement of Object likenesses in predefined locations in the Multi-Media Program, as reserved by predefined Multi-Media Object Locations, to correlate the product placement in the Multi-Media Program with the Object preferences of the recipient.

### BACKGROUND OF THE INVENTION

It is a problem in the field of multi-media content to provide the advertiser with the flexibility to deliver a set of advertisements that target a specific audience or recipient on a dynamic basis. The present-day efficiency of mass media advertising is very low—advertising dollars do not achieve high levels of purchase decisions due to lack of recipient targeting. “Commercial Break” advertising interrupts the flow of a programs content, and consumer devices enable recipients to completely skip the “commercial break”. New media devices such as e-readers for books or magazines are presently not personalized. Likewise, the delivery of video content to mobile devices such as cell phones, while in its infancy, is not contemplated to be personalized; hence, the advertising across this new media also is not personalized. Similarly, multi-media programming on the Internet may offer ads such as banners or other ad forms that essentially overlay displayed content—none of which are targeted or dynamically targeted Current multi-media products and services do not permit highly targeted advertising, an archaic paradigm in which the recipients' needs and wants and desires are not directly influenced; rather, these needs, wants, and desires can be missed entirely.

Devices such as DVRs Digital Video Recorders) and TiVo enable recipients to completely bypass mass media and targeted commercial breaks by simply “fast-forwarding” the broadcasted multi-media content to bypass the commercials. This recipient action effectively negates the delivered value of traditional multi-media content advertising. In addition, the traditional ad insertion methods for television and radio do not permit continuous flow of multi-media content like that when going to a movie theater to see a feature length movie. The advertising interrupted multi-media content does not provide an optimum viewing or listening experience for the recipient.

Concepts such as static product placement directly into the multi-media content stream have the advantage that it is virtually impossible for the recipient to bypass the “product placement advertisement” using DVR technology. However, the present art for static product placement does not provide the capability to dynamically change the inserted product to match the demographic, psychographic, or sociographic characteristics of the recipient. Thus, the opportunity to micro-advertise directly to a given recipient using product placement is technologically unavailable.

The traditional method of advertising has been to broadcast a common advertisement to a large audience via mass media, such as newspapers, magazines, radio, and television. This mass media advertising strategy seeks to reach the greatest number of recipients thereby to increase the odds of contacting the recipients most likely to purchase the advertised product or service. Although a large viewing audience may see the advertisement, advertisers understand that only a small percentage of that audience has a real interest in purchasing the advertised product or service.

In order to offset this unnecessary spending, advertisers continually strive to narrow advertising efforts to a targeted purchasing audience. The importance of measuring advertising's effectiveness is critical—it determines whether an ad campaign will be effective and also enables the advertiser to more effectively manage the productivity of a given advertising campaign. These objectives are so important that organizations such as Nielsen are planning to track advertising popularity or viewership. One targeting advertising method distributes commercials, which are inserted into the media stream at predetermined program break locations, to attract demographic groups likely to purchase the advertised product or service. For example, television shows often appeal to a particular type of audience, marked perhaps by age, income, or education. Usually, the specific sponsors of the shows sell products that appeal to the same particular audience. In addition, cable and satellite broadcast systems can insert commercials at predetermined program break locations on a regional basis to target local audiences with local commercials. For example, a television broadcaster in Denver may insert and play a Chevrolet ad, while in Boston, the ad slot is replaced or “cut-out” and an Audi ad is inserted. For “zip code” advertising, the cable TV head-end may insert a unique advertisement in a broadcasted TV program for a given zip code (which may or may not have similar recipient demographic attributes depending on the demographic make-up of the “zip code” region). Still, even these levels of advertising granularity do not solve the problem of eliminating the insertion of an advertisement and breaking the continuous flow of the multi-media content stream; furthermore, the advent of DVRs enable the recipient to completely bypass even these more highly targeted ads. In addition, other technologies are also now available to mute or skip over these commercials, so their advertising impact is nullified (the technologies “sense” or know when the content stream switches from program material to commercials and skips or deletes the commercials).

In another consumer targeting method, advertisers pay the mass media content creator to deliver advertisements as an integral part of the multi-media content, and this process is termed “product placement.” This method embeds the advertisement in the multi-media content such that the recipient views the advertisement as part of the multi-media content. For example, actors or actresses use the advertiser's products during their acting, or the products are prominently displayed as part of the stage set during the program; these are called product placements. For example, a television program could contain 30-second commercial breaks and static product placements. These types of product placements are static and become a permanent part of the television program or movie.

Traditionally, product placement is a form of advertising that is done in the creation of the static original multi-media content to deliver “advertising” to the recipient without interrupting the program stream for a formal, traditional commercial (e.g., break the program stream delivery and insert a 30-second advertisement). The prominent placement of a product as part of the multi-media content generates brand recognition with the recipients in a manner that is far more subtle and unobtrusive than traditional commercials. In fact, it can actually create higher brand awareness because of the direct actor-actress interaction with the product (or service).

In a feature length movie, advertising is implemented using the strategy of product placement—a Coke® can being held by an actor has the effect of creating brand awareness for Coca-Cola™. However, this product placement is static in its implementation since the feature length movie always has the same graphical rendition of the original Coke® can (when the movie was made), even though the feature length movie could become a classic that is re-played many years in the future. It is presently not possible to dynamically modify the original Coke® can to represent the present day rendition of the new, modern Coke® can, say, 10 years hence.

Unfortunately, present-day product placement suffers from some of the same drawbacks of broadcast commercials, since they are immutable and delivered to the entire audience, with no ability to dynamically modify the product placement to target selected audience segments or individual recipients; nor can the product placements be updated over time.

### BRIEF SUMMARY OF THE INVENTION

The above-described problems are solved and a technical advance achieved in the field by the present System For Highlighting A Dynamic Personalized Object Placed In A Multi-Media Program (termed “multi-media object highlighting system” herein) which functions to highlight selected Objects in a multi-media object management system which manages the delivery of Object (product) placements in a Multi-Media Program. The multi-media object highlighting system controls the retrieval of Object data that comprises a product representation and the integration of this Object data into a corresponding selected one of the predetermined Multi-Media Object Locations which are components of the Multi-Media Program. The multi-media object management system enables advertisers to precisely control Object (product) placement on a customized basis thereby to dynamically modify the content of the Multi-Media Program on a centralized basis, regional basis, or at the individual recipient's location. In addition, the multi-media object highlighting system produces a representation of the object that highlights the object in the scenes in which it appears. The highlighting can be any human sensible characteristic, such as, but not limited to: flashing, changes in brightness, movement, change in representation, and the like. The highlighting can also include the use of an anomaly, such as a color representation in a black and white multi-media program or a black and white representation in a color multi-media program, or out-of-context object, such as an object inappropriate for the time frame of the program content. Object highlighting could be multi-dimensional, wherein the object takes on the appearance of a three-dimensional shape in the context of a two-dimensional visual program (the converse could also be true; that is, the object could be two-dimensional and the program content three-dimensional). This juxtaposition of dimensions would make an object “stand-out” with respect to the program content. In addition, the highlighting may occur in another sensory form other than visual; such non-visual highlighting could be aural (audio) in nature and in this example could take, for example, the form of a different engine sound or a louder engine sound of a dynamically placed automobile. Highlighting could also invoke other senses such as smell; in this case, when an object were displayed, an aroma-emitting device would emit the correct aroma for that particular object as well as, in the optimum recipient-object matching paradigm, match the aroma to the intended recipient. Object highlighting could even include the sense of touch; an example would be sitting in a special chair or theater environment that would, for example, cool the chair and blow cool air at the recipient to enhance the refreshing, cool sense of eating a dynamically placed object such as an ice cream bar on a hot summer day.

In the multi-media object management system, the production of the Master Program that is used to create the Multi-Media Program typically results in the presence of a plurality of Objects within the Master Program. The multi-media object management system defines a plurality of Multi-Media Object Locations within the Master Program as components of the Multi-Media Program and creates Object management data that is used to control the population of these spatial and temporal Multi-Media Object Locations with Objects. These Multi-Media Object Locations can receive animation, audio, moving Objects, stationary Objects, and any other dynamic data. The Multi-Media Object Locations are an integral part of the Multi-Media Program and their content can be manipulated by referencing a specified Multi-Media Object Location and populating that specified Multi-Media Object Location with a predetermined representation from the Objects stored in the database. Thus, the image of a beverage can in a Multi-Media Program is populated by any of a number of specific brands of beverages, by importing a predetermined representation of the desired brand of beverage into the predefined Multi-Media Object Location that is an integral part of the Multi-Media Program. The multi-media object highlighting system enables dynamic product placement in the delivery of a program to a recipient. The Object Metafile contains all of the necessary instructions for highlighting a given dynamically placed object to include how that highlighting could be matched to a given recipient.

In addition, by collecting data on recipient viewing habits and analyzing that data in light of other recipient account information (from other databases), the multi-media object management system is able to intelligently select and display products or services to a recipient who is truly interested in purchasing these displayed products or services. Further, the multi-media object management system can deliver different advertisements to different recipients watching the same program or channel. Thus, the multi-media object management system reaches a large audience (e.g., a cable television audience), assesses the interests and tastes of each recipient of that audience, and delivers imbedded advertisements to each recipient for products or services that the recipient is predisposed to purchase. The net result is a more efficiently spent advertising dollar for the sponsors and an increased profit margin for the network media providers.

Imagine a whole new promotional paradigm where standard commercials as we know them become a thing of the past, a world where 60-minute television shows are really 60 minutes instead of 50 minutes of content and 10 minutes of commercials.

In the new world of “in situ advertising”, 30-second commercial breaks become a thing of the past. Products and services now become dynamic Objects (product placements), easily manipulated and adapted based on national, regional, state, local, or even individual household delivery standards as set by advertisers and consumers alike. In this world, not only can an advertiser choose to tailor their delivery to a specific audience, the consumer can also choose which products they are most interested in seeing and thus most likely to purchase (pull advertising vs. traditional push advertising). This ultimate degree of matching advertising to a given recipient is unparalleled.

As we move into an era where promoting products and services via standard commercial television is becoming less and less effective because of the sheer number of choices of available channels each having a content focus, and with the advent of digital video recorders that allow for either cutting out commercials entirely or fast forwarding through them, a new and innovative advertising delivery method is necessary to effectively deliver required and critical advertising and promotional messages while still successfully engaging the recipient to continue watching the show of their choice without interruptions.

With “in situ advertising”, goods and services can now be promoted by directly inserting them into the very fabric of the show being viewed in a dynamic fashion that is substantially flexible and manageable (and malleable) from a very high level (national items such as Coke®, Pepsi®, Ford®, or McDonald's®) down to an extremely local level that can be targeted to an individual household (grocery store, restaurant, dry cleaner, beauty salon, etc.). The idea of promotional product placement is not a new one; what is innovative in this process is that the promotional placement can be dynamically changed and adapted to highly precise market and delivery conditions. In addition, the multi-media object highlighting system operates in the multi-media object management system and produces a representation of the object that highlights the object in the scenes in which it appears in order to draw attention to itself, but without detracting from the content of the Multi-Media Program. The highlighting can be any human sensible characteristic, such as, but not limited to: flashing, changes in brightness, movement, change in representation, and the like. The highlighting can also include the use of an anomaly, such as a color representation in a black and white multi-media program or a black and white representation in a color multi-media program, or out-of-context object, such as an object inappropriate for the time frame of the program content. As described, the highlighting can be non-visual in nature. Any of the described highlighting elements or methods can be implemented individually, such as visual only, or can be implemented in concert with other sensory methods such as visual, aural, smell, and touch all combined for a given object.

Traditionally, product placement has been limited to whatever placement can be done at the time of filming or content creation. The future involves a process whereby all product placement is infinitely dynamic and flexible because it can be changed at will and by location and by recipient's profile. This allows marketers to focus their promotional needs to an exact target market, raising the consumers' propensity to buy to the highest level.

### BRIEF DESCRIPTION OF THE DRAWINGS

FIG. 1 illustrates, in flow diagram form, the flow of program materials in the multi-media object management system;

FIG. 2 illustrates, in block diagram form, the operation of the multi-media object highlighting system in generating a highlighted representation of the selected Object;

FIG. 3A illustrates, in block diagram form, the overall architecture of the multi-media object management system using a centralized Object insertion paradigm;

FIG. 3B illustrates, in block diagram form, the overall architecture of the multi-media object management system using a regional Object insertion paradigm;

FIGS. 3C and 3D illustrate, in block diagram form, two overall architectures of the multi-media object management system using a localized recipient based Object insertion paradigm;

FIG. 4A illustrates, in block diagram form, the overall architecture of a typical content source system;

FIG. 4B illustrates, in flow diagram form, the operation of a typical content source system;

FIG. 5A illustrates, in block diagram form, the overall architecture of a typical Object Insertion Processor;

FIG. 5B illustrates, in flow diagram form, the operation of a typical Object Insertion Processor;

FIG. 6 illustrates three frames of a Multi-Media Program and a representation of these three frames using a selected Object to populate the Multi-Media Object Location in these frames, which form a Multi-Media Object Location “Set”; and

FIG. 7 illustrates the distribution of a single frame of a Multi-Media Program to multiple Recipients in multiple Regions with the Multi-Media Object Location in the frame being populated with a different Object for each Region.

### DETAILED DESCRIPTION OF THE INVENTION

Traditionally, product placement is a form of advertising that is done in the creation of the original Multi-Media Program to present “advertising” to the recipient without interrupting the program for a formal, traditional commercial. The prominent placement of a product as part of the Multi-Media Program functions to generate brand recognition with the program recipients in a manner that is far more subtle and unobtrusive than traditional commercials.

The multi-media object management system controls the retrieval of Object data that comprises an Object Representation and Object Characteristics and the integration of this Object data into a corresponding selected one of the predetermined Multi-Media Object Locations which are components of the Multi-Media Program. This enables advertisers to precisely control product placement on a customized basis thereby to dynamically modify the content of the Multi-Media Program on a centralized basis, a regional basis, and/or as it is delivered to the individual recipient. The delivery can also be based on demographic, psychographic, or socio-graphic groupings, which mayor may not be geographically proximate.

In the multi-media object management system, the process of creating the Multi-Media Program takes “Master Program” content and typically defines a plurality of Multi-Media Object Locations (although at least one Multi-Media Object Location is considered to be the minimalist subset) together with Object Management Data, which is collectively termed herein as “Object Ready Content”. These Multi-Media Object Locations are sites in the Master Program that can receive animation, audio, moving Objects, stationary Objects, and any other dynamic data, whether uni-dimensional, two-dimensional, three-dimensional, or multi-dimensional. The Object Ready Content is now ready to receive selected Objects.

The Object selection process for a given Multi-Media Object Location having spatial and temporal attributes is finally processed by reconciling Object Characteristic data with Object Management Data together with Master Program Rule Set information and Recipient Data (not always necessary or available, in particular, if the Object insertion is done in the central architecture, there would not be any Recipient Data). In addition, the Object Location Brokerage can have bi-directional connections to the reconcile process, as needed. This reconcile process ensures that the purchase process has not resulted in the placement of inappropriate objects or the selection of an object that cannot be used to populate the selected Multi-Media Object Location.

In addition, the present multi-media object highlighting system produces a representation of the object that highlights the object in the scenes in which it appears. The highlighting can be any human sensible characteristic, such as, but not limited to: flashing, changes in brightness, movement, change in representation, and the like. The highlighting can also include the use of an anomaly, such as a color representation in a black and white multi-media program or a black and white representation in a color multi-media program, or out-of context-object, such as an object inappropriate for the time frame of the program content. Object highlighting could be multi-dimensional, wherein the object takes on the appearance of a three-dimensional shape in the context of a two-dimensional visual program (the converse could also be true; that is, the object could be two-dimensional and the program content is three-dimensional). This juxtaposition of dimensions would make an object “stand-out” with respect to the program content. In addition, the highlighting may occur in another sensory form other than visual. The output of this complex process is the Multi-Media Program.

### Definitions

In order to ensure a proper understanding of the present multi-media object highlighting system, the following definitions are provided to clarify the terminology used herein.
Master Program—the Master Program produced by the creative staff as the essential “story” being presented in the Multi-Media Program. A Master Program can take the form of a movie, a television show, an internet short clip, a mobile TV news program, an audio stream, a video stream, an e-magazine on an e-reader using digital ink, and the like.
Master Program Rule Set—a set of rules defined by the originator or owner of the Master Program to regulate the options available to the multi-media object highlighting system to place Objects into the Master Program at the defined Multi-Media Object Locations.
Multi-Media Object Location—spatial and temporal locations in the Master Program that can receive animation, audio, moving Objects, stationary Objects, and any other dynamic data, whether uni-dimensional, two-dimensional, three-dimensional, or multi-dimensional.
Object Ready Content—a copy of the Master Program once it is processed to incorporate the Multi-Media Object Locations and associated Object Management Data.
Object Management Data—Object-centric information that is part of the Object Ready Content and is used to define the attributes of the Multi-Media Object Locations, such as the Object type, the Object location, the time and place or extent in the Multi-Media Program where a Multi-Media Object Location occurs, the number of dimensions that a given Object has (video and audio or just video, for example), and how long an Object “lives”.
Object—a uni-dimensional or multi-dimensional entity (or product or thing or item or article) having Object Characteristics. An Object may be a product representation, an image likeness of a living being such as a dog or a person's face, and the like. Objects can be dynamic or static depending on the advertising objective. An Object can also be other than multi-media, such as in the case of a document or document-like display.
Object Characteristic Data—the set of data that defines the content of an Object, including the class of Object, identification of the owner of the Object, limitations (if any) on the use of the Object, and so on. The characteristics or attributes of an Object can be uni-dimensional or multi-dimensional and can include, but are not limited to: video (moving images), still images, audio, audio that is matched with a given Object, other senses such as feel-smell-taste, and the like. An Object such as a cup of coffee could have a brand logo, an image, and an aroma. A typical Object Characteristic would be two-dimensional having an image (or visualization or rendering) and could have an associated sound clip. In addition, the Object Characteristic Data can include a Highlighting specification that defines a type of Highlighting that is applied to the Object when it is inserted into the selected Multi-Media Object Location. Object Characteristic Data can also be called an Object Metafile, wherein such Metafile embodies all of the attributes of a given Object.
Highlighted Object—an Object which has been modified or enhanced in at least one sensory form to improve its prominence to the recipient. Hereto, a Highlighted Object has been attached to the given Object, Object Characteristic Data, or an Object Metafile.
Object Insertion Process—the means and methods for inserting Objects into Multi-Media Object Locations, including the Highlighting of the Object.
Recipient Data—the demographic, psychographic, or socio-graphic profile of a given recipient that can include the viewing habits of the recipient, on an aggregate or temporal basis.
Merged Content Stream—a combination of the Object Ready Content with only a subset of the Multi-Media Object Locations populated.
Multi-Media Program—the Object Ready Content with all of the Multi-Media Object Locations populated and ready for delivery to a recipient.

### Flow of Program Materials in the Multi-Media Object Highlighting System

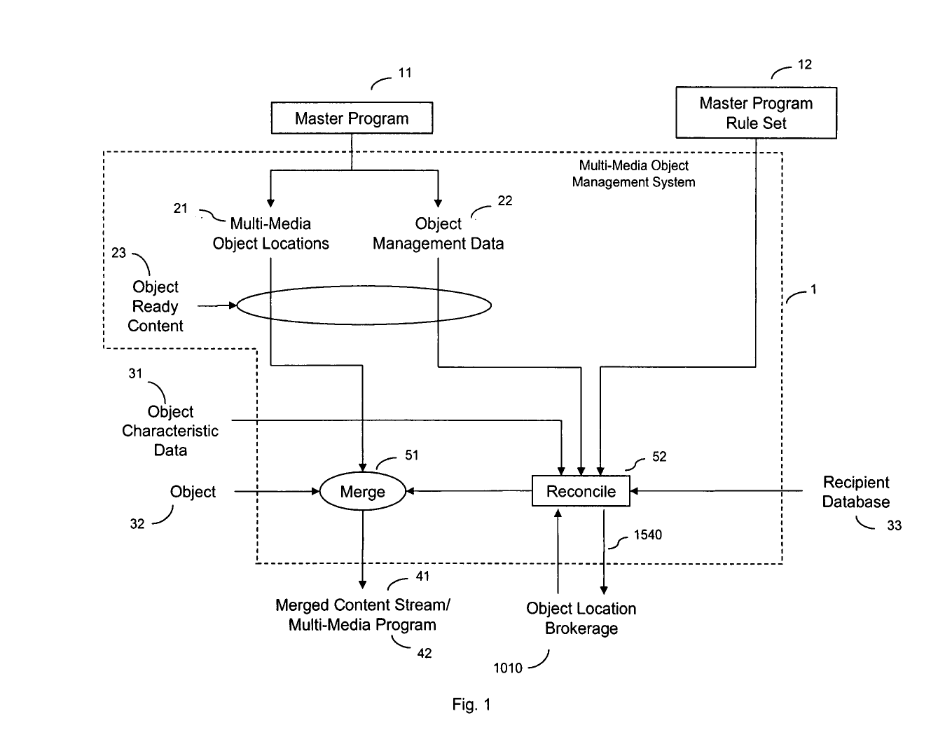

FIG. 1 illustrates, in flow diagram form, the flow of program materials in the multi-media object management system 1 in which the multi-media object highlighting system is operational. The Master Program 11 is the master multi-media content that is produced by the creative staff of a multi-media production company as the essential “story” being presented in the Multi-Media Program 42. This can be a television show, a movie, or other such multi-media presentation. Similarly, it could also be an e-magazine delivered electronically to an e-reader using digital ink. In the creation of the Master Program 11, various “props” are typically used as stage setting or as part of the storyline and these can include motor vehicles, beverage containers, signage, furniture, etc. These props can be non-standard products that are designed to have characteristics that facilitate automatic detection by a processing program (such as a traditional chroma-key blue or green wherein Objects are later inserted into the “hole” created by the blue or green Chroma-Key Multi-Media Object Location 21 space), or they can be standard products. While this is one algorithm or method to create the Multi-Media Object Locations 21, the Multi-Media Object Locations 21 can also be created electronically after the Master Program 11 has been finished through manual or other automatic means. The Master Program Rule Set 12 is a set of rules defined by the originator or owner of the Master Program 11 to regulate the Object insertion options available to the multi-media object highlighting system to place Objects 32 into the Master Program 11 at the defined Multi-Media Object Locations 21. This rule set can operate generically on certain defined classes of products or can specifically target predetermined Objects 32 in the Master Program 11. As an example, the originator or owner of the Master Program 11 may have strong beliefs concerning smoking and would prohibit cigarette advertising in their owned content.

The Master Program 11 and its associated Master Program Rule Set 12 are received by the multi-media object management system 1 and then processed to identify Multi-Media Object Locations 21 contained in the Master Program 11 that are to be used for Object placement in conjunction with Object Management Data 22. The Objects 32 can be identified uniformly throughout the Master Program 11 (every instance of an Object 32) or can be selectively targeted. The multi-media object management system 1 creates Multi-Media Object Locations 21, which are sites in the Master Program 11 that can receive animation, audio, moving Objects, stationary Objects, and any other dynamic data, whether uni-dimensional, two-dimensional, three-dimensional, or multi-dimensional. Each of these Multi-Media Object Locations 21 have associated therewith Object Management Data 22 which are Object centric information that is associated with the Multi-Media Object Location 21, such as the Object type, the Object location, the time and place or extent in the Multi-Media Program 42 where an Object 32 occurs, the number of dimensions that a given Object 32 has (video and audio or just video, for example) and how long an Object 32 “lives”. Once the processing of the Master Program 11 is completed, the resultant product is termed Object Ready Content 23 and consists of a copy of the Master Program 11 once it is processed to contain the Multi-Media Object Locations 23 and the associated Object Management Data 22.

The Object Ready Content 23 comprises the processed Master Program 11 and Object Management Data 22 and is described below as being transported directly or via a distribution network 120 from the Content Source 101 to the Object Insertion Processor 110 in order to provide the content stream that can be populated with selected Objects 32. However, the Object Ready Content 23 that is stored in Content Source 101 can be written to removable media for physical distribution to locations where the Object Insertion Processor 101 resides. Thus, conceptually, the distribution network 120 can comprise a physical media delivery operation. The Object Ready Content 23 produced by the Content Source 101 itself becomes a product that can be sold to recipients for use in their personal media players (such as a DVD or High Definition DVD or some future technology such as a 3-D media disk and player). The personal media player, when connected to a communications network or using its own memory which is populated with Objects, can retrieve the Object Ready Content 23 from the removable media and access the Object Source 102 to retrieve the selected Objects 32 and populate the Multi-Media Object Locations 21 in the Object Ready Content 23 to produce the Multi-Media Program for display to the recipient on their personal media player. A further example of this capability is where the recipient purchases the Multi-Media Program at a retail outlet, but also presents a removable media that contains Objects written thereon for insertion into the Multi-Media Program to personalize the Multi-Media Program. As an example, the recipient's media can contain Objects that comprise likenesses of the recipient and/or various acquaintances, which likenesses are to be merged into the Multi-Media Program, appearing for example as extras or bit players in a movie, or providing the recipient's favorite products in the Multi-Media Program (or a video game, to include multi-player video games inter-connected via the Internet).

In addition, there is a processing operation that takes place to create Objects 32, which are product representations, each of which has associated therewith Object Characteristics 31 consisting of the set of data that defines the content of an Object 32, and associated data including the class of the Object, identification of the owner of the Object, and limitations (if any) on the use of the Object. Therefore, Objects 32 consist of the elements that are used to populate the Multi-Media Object Locations 21 that have been created within the Object Ready Content 23.

Once the Object Ready Content 23 stream is scheduled to be delivered to recipients, a Merged Program Stream 41 is created, which consists of a combination of the Object Ready Content 23 with a full set or a subset of the Multi-Media Object Locations 23 populated. The Multi-Media Object Locations 21 are populated on a centralized, regional, and/or localized basis (or a demographic, psychographic, or socio-graphic groups which may or may not be geographically proximate) by a Merge function 51, and the final product is the Multi-Media Program 42 which consists of the Object Ready Content 23 with all of the Multi-Media Object Locations 21 populated and ready for delivery to a recipient. Included in the Merge function 51, the multi-media object highlighting system produces a representation of the Object that highlights the Object in the scenes in which it appears. The highlighting can be any human sensible characteristic, such as, but not limited to: flashing, changes in brightness, movement, change in representation, and the like. The highlighting can also include the use of an anomaly, such as a color representation in a black and white multi-media program or a black and white representation in a color multi-media program, or out-of-context Object, such as an Object inappropriate for the time frame of the program content. Object highlighting could be multi-dimensional, wherein the Object takes on the appearance of a three-dimensional shape in the context of a two-dimensional visual program (the converse could also be true; that is, the Object could be two-dimensional and the program content is three-dimensional). This juxtaposition of dimensions would make an Object “stand-out” with respect to the program content. In addition, the highlighting may occur in another sensory form other than visual.

The population of the Multi-Media Object Locations 21 with Objects 32 is controlled not only by the appropriateness of the Object 32 in the Master Program 11 as identified by the Master Program Rules Set 12 and the Object Characteristic Data 31, but also by the purchasing of the Multi-Media Object Locations 21 by advertisers to have their products displayed in the Multi-Media Program 42 as identified in the Object Location Brokerage 1010 and the recipient-specific characteristics as identified in Recipient Database 33. There are numerous procedures that can be used to effect the purchase and management of the Multi-Media Object Locations 21, and these result in the creation of a set of attribution data that defines the particular Object 32 that is to be used to populate a selected Multi-Media Object Location 21, subject to the Master Program Rule Set 12, the Object Characteristic Data 31, and the Object Management Data 22 confirming the selection (and optionally the Recipient Data 33). The management of the Multi-Media Object Locations 21 is performed in the Reconcile Processor 52 to ensure that the proper Object 32 is populated into the proper Multi-Media Object Location 21.

### Overall System Architecture—Centralized and Regional

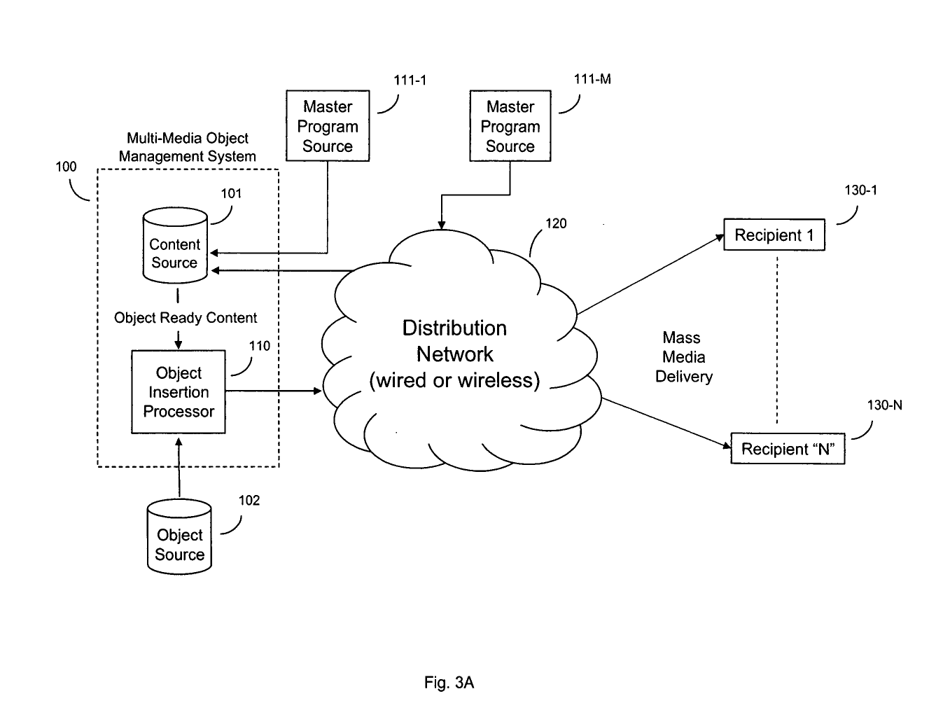

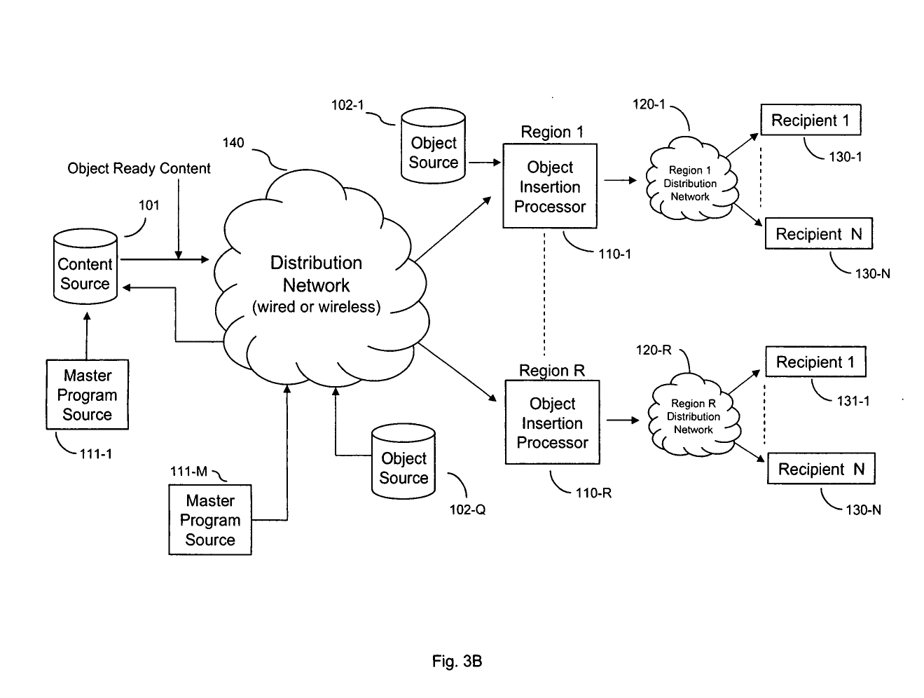

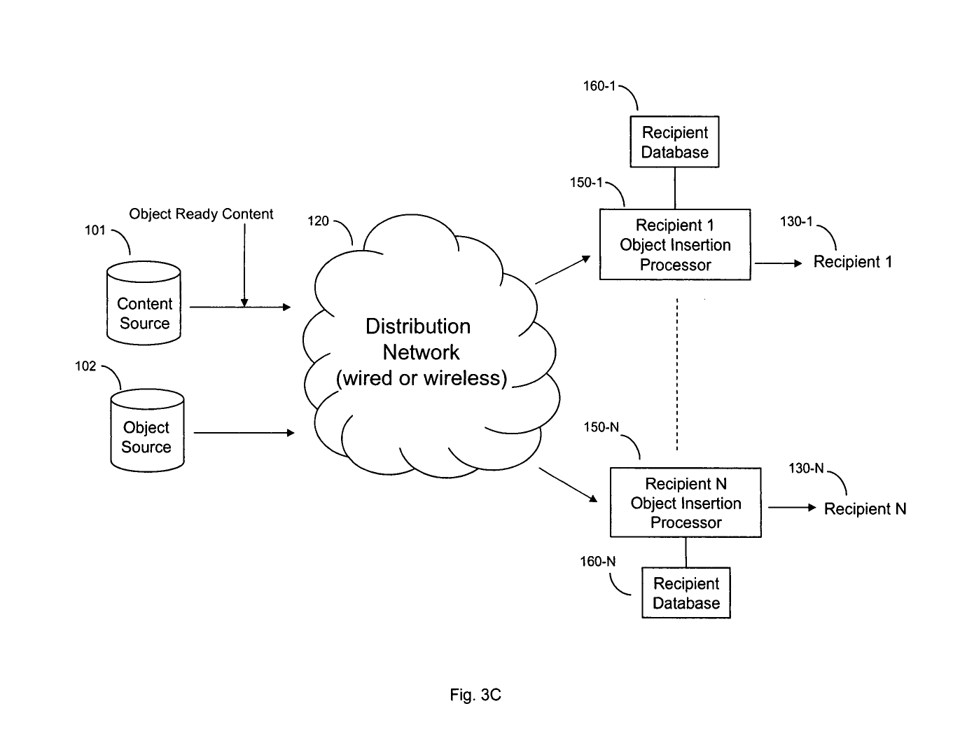

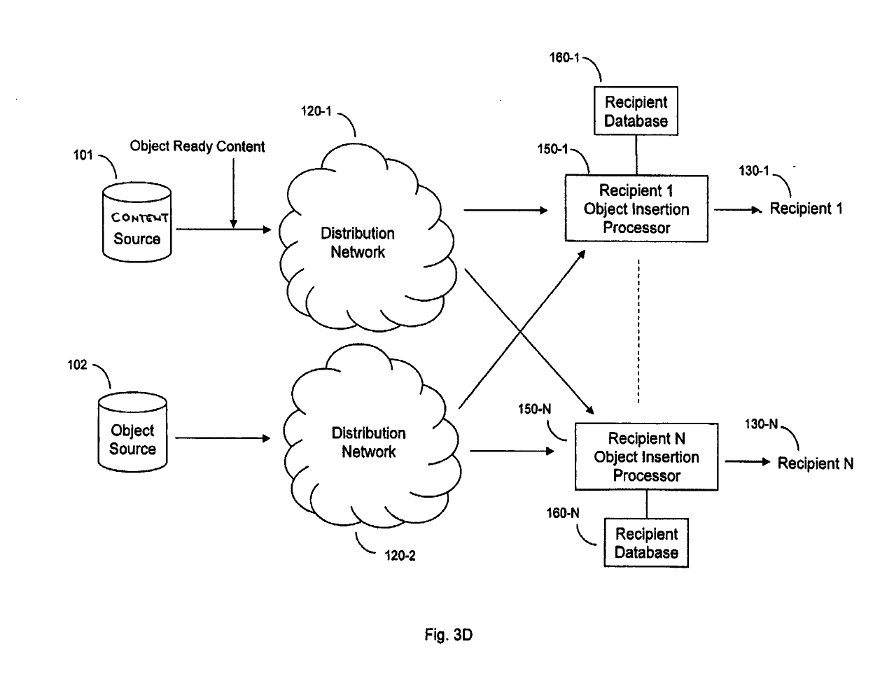

FIG. 3A illustrates, in block diagram form, the overall architecture of the multi-media object management system using a centralized Object insertion paradigm. The multi-media object management system functions as a Centralized Object Insertion Site 100 and is architected for a mass market or mass media audience where the recipients, 130-1 to 130-N, (Recipient 1 to Recipient N, respectively) share a common demographic profile or are believed to be receptive to the message conveyed or the Object 32 that is to be inserted by this process is of sufficient general interest to be delivered to all of the recipients, without distinction.

The Object 32 is inserted into the Multi-Media Program 42 at the Centralized Object Insertion Site 100 before delivery of the Multi-Media Program 42 across a distribution network 120 where all recipients 130-1 to 130-N observe or experience the same inserted Object 32. With centralized insertion, the object management technology resides at a central location, Centralized Object Insertion Site 100, with Objects 32 stored in an Object Source 102 and Object Ready Content 23 stored as data files in a Content Source 101. The Object Ready Content 23 that is stored in Content Source 101 can be generated in its entirety at the Centralized Object Insertion Site 100, or produced by manipulating Master Program 11 that is received directly from Master Program Source 111-1 or received via distribution network 120 from Master Program Source 111-M.

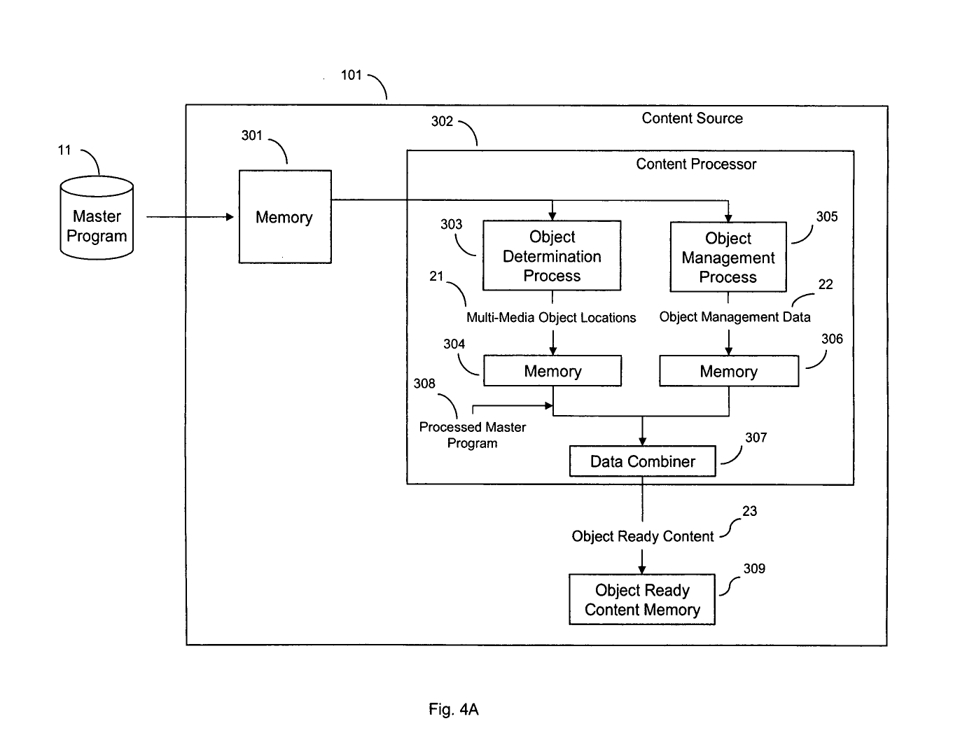

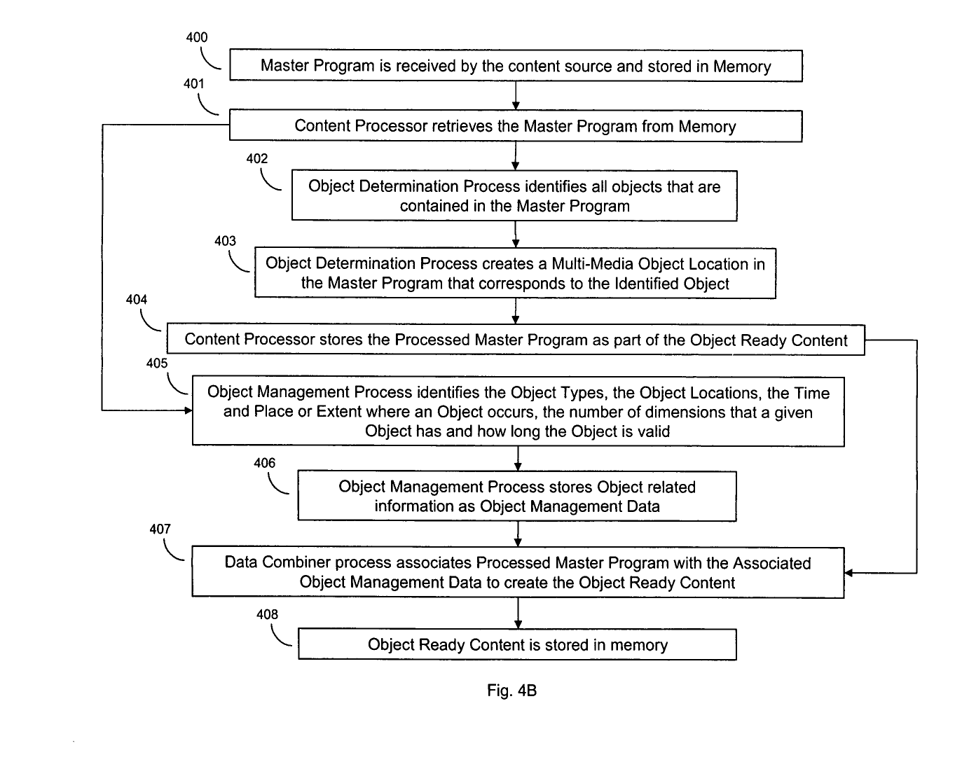

The content stored in the Content Source 101 contains graphical, visual, and aural information plus Object centric information, such as the Object type, the Object location, the time and place or extent in the Multi-Media Program 42 where an Object 32 occurs, the number of dimensions that a given Object 32 has (video and audio or just video, for example) and how long an Object 32 “lives”. This is described below in more detail with respect to the Content Source description of FIGS. 4A and 4B. Both Objects 32 and Object Ready Content 23 are retrieved from their respective repositories 102, 101 by the Object Insertion Processor 110 and merged into a single data stream for delivery across a distribution network 120 to all recipients 130-1 to 130-N. The deployment cost of a centralized system is less than other architectures since it doesn't have to replicate the Content Source 101, the Object Insertion Processor 110, and the Object Source 102.

FIG. 3B illustrates, in block diagram form, the overall architecture of the multi-media object management system using a Regional Object Insertion paradigm. Regional Object Insertion involves “sliding” downstream (closer to the recipient) where the Objects 32 are inserted into the selected Multi-Media Object Locations 21 in the Merged Content Stream 41. The Content Source 101 can remain centrally located. Other variations could have the Content Source 101 being replicated on a regional basis if the content needs to change based on regional demographics. Likewise, the word “region” could be replaced with the words “like interest” or “common demographic” which would then form an N×M matrix of possible Object 32 insertions for a given locale. More likely, however, the Recipient Location Object Insertion, as described herein, would be the preferred paradigm vs. forming an N×M matrix of the Regional approach. The multi-media object management system, therefore, is implemented in a distributed manner, rather than the elements that comprise this system being co-located.

In the Regional architecture illustrated in FIG. 3B, the Content Source 101 is centrally located. The Object Ready Content 23 that is stored in Content Source 101 can be produced by manipulating Master Program 11 that is received directly from Master Program Source 111-1 or received via distribution network 140 from Master Program Source 111-M. This Object Ready Content 23 is distributed via a distribution network 140 to regionally located Object Insertion Processors 110-1 to 110-P, where locally proximate or network connected Object Source databases 102-1 to 102-Q, respectively, are fed into Object Insertion Processors 110-1 to 110-P. The Object Ready Content 23 can contain logical information describing which Object 32 should be inserted at what point in the content stream on a region-by-region basis (or a demographic-by-demographic basis as an alternative). Alternatively, this decision can be made at the Object Insertion Processor 110-1 to 110-P based on data received via an alternative path. Objects 32 are multi-dimensional and can have the form of visual and aural information integration (an example would be a motorcycle which has a unique sound, i.e., Yamaha® vs. Harley Davidson®). Objects 32 could also have the multi-dimensional attributes of smell, taste, and touch (you smell the burning rubber of the tires, you taste the fine liquor, or you feel the vibration of an earthquake all being Object Characteristic Data 31). Ultimately, Object Ready Content 23 with regionally targeted Objects 32 are delivered via respective networks 120-1 to 120-R to Recipients 130-1 through 130-N and 131-1 through 131-N for that respective region.

### Content Source

FIG. 4A illustrates, in block diagram form, the overall architecture of a typical content source system 101; and FIG. 4B illustrates, in flow diagram form, the operation of a typical content source system 101. The Master Program 11 is stored in Memory 301 and then processed as described herein to produce the Object Ready Content 23. The processing of Master Program 11 is described herein to illustrate the process of creating Multi-Media Object Locations 21 and managing these for the insertion of Objects 32 into the Object Ready Content 23.

The Content Source algorithm contains a number of key building blocks which create Object Ready Content 23. Master Program 11 is content that is not Object ready. It becomes Object Ready Content 23 after the identification of all Multi-Media Object Locations 21, wherein a Multi-Media Object Location 21 is created in the Master Program 11 and corresponding Object Management Data 22 which comprises Object centric information, such as the Object type, the Object location, the time and place or extent in the Multi-Media Program where an Object occurs, the number of dimensions that a given Object has (video and audio or just video, for example), and how long an Object “lives”.

At step 400 (FIG. 4B), the Master Program 11 is received by the Content Source 101 and stored in memory 301. The Content Processor 302 retrieves the Master Program 11 from memory 301 at step 401 and identifies all Multi-Media Object Locations 21 that are contained in the Master Program 11 at step 402, using an Object Determination Process 303. This can be done automatically, such as by using props (cans, cars, etc.) in the creation of the Master Program 11 that are automatically identifiable by the Content Processor 302 via certain unique characteristics of the props that make them distinguishable from non-Objects in the Master Program 11. The Content Processor 302 then creates a Multi-Media Object Location 21 in the Master Program 11 at step 403 that corresponds to the identified Object 32 and then stores the processed Master Program 308 in memory 304 at step 404.

Along a parallel algorithmic path, the Object Management Process 305 uses the retrieved Master Program 11 and identifies at step 405 the Object types, the Object location, the time and place or extent where an Object 32 occurs, the number of dimensions that a given Object 32 has (video and audio or just video, for example), and how long an Object 32 “lives”. For example, a movie that is broadcast in 2008 and then again in 2010 quite likely has different Objects 32 being used. The Object Management Process 305 at step 406 stores this Multi-Media Object Location-related information as Object Management Data 22 in memory 306. The Object Management Data 22 contains all of the aforementioned Object attributes and is used to convey this information downstream to the Object Insertion Processor 110.

The Data Combiner Process 307 combines the Processed Master Program 308 with the associated Object Management Data 22 at step 407 to create the Object Ready Content 23 which is stored in Object Ready Content Memory 309 at step 408.

The above-mentioned steps 404, 406 of storing file data may be unnecessary if the Data Combiner Process 307 processes the generated data in real time, and writes the resultant Object Ready Content 23 to the Object Ready Content Memory 309. Likewise, ultra-fast processing and delivery methods may not require Object Ready Content Memory—in this case, the Processed Master Program could be streamed “live” to the Object Insertion Processor, wherever it is located; this architecture modification is likely for a “live” content program such as a sporting event.

### Object Characteristics

Each Object 32 has a plurality of characteristics that define the owner of the Object 32, the representation of the Object 32 in a program (static, adaptable, dynamic), the content of the Object 32 (product identification and limitations on its use), as well as other data that are appropriate for the management of the Object 32 in the Multi-Media Program 42 context. Object Characteristics Data 31 include the set of data that defines the content of an associated Object 32, including the class of Object, identification of the owner of the Object, and limitations (if any) on the use of the Object. The characteristics or attributes of an Object can be uni-dimensional or multi-dimensional and can include, but are not limited to: video (moving images), still images, audio, audio that is matched with a given Object, other senses such as feel-smell-taste, and the like. An Object such as a cup of coffee could have a brand logo, an image, and an aroma. A typical Object Characteristic would be two-dimensional having an image and an associated sound clip.

### Multi-Media Object Location

Like the Object 32 having ownership, Multi-Media Object Location 21 has an owner associated with it as well, albeit different than Object 32 ownership. However, when comparing the ownership of the Object 32 versus the Multi-Media Object Location 21, the Object 32 is often a branded or trademarked product or service owned by a given company where the company has absolute ownership of all rights associated with its Object 32, while the “ownership” of the Multi-Media Object Location 21 is most often retained by the owner of the Multi-Media Program 42. From the advertiser's perspective, the use of Multi-Media Object Location 21 is generally transient and takes the form of a lease (although it is possible for a company to purchase Multi-Media Object Location 21 rights in perpetuity albeit said lease rights being substantially more expensive than the transient right). The transient lease rights of a Multi-Media Object Location 21 can be one-time-only, multiple play, just-in-time (rights auction just before real time delivery to the Recipient) and so on.

### Multi-Media Object Insertion—Identical Characteristics And Matched Class

In the case where a selected Object 32 is identical in its “footprint” with the Multi-Media Object Location 23 defined in the Multi-Media Program 42, the Object insertion process is a simple substitution. Thus, a standard size soda can is fungible and the only delimiting factor is the label applied to the standard size soda can to identify the contents and the company that has produced this product. The selected Object must also be reviewed to determine whether the content of the Object is appropriate for the selected placement in the program. Thus, a can of motor oil would be an inappropriate selection to be displayed on the kitchen counter of a cooking show in place of a can of tomatoes.

### Multi-Media Object Insertion—Different Characteristics and Matched Class

In the case where a selected Object 32 is not identical in its “footprint” with the Multi-Media Object Location 23 defined in the Multi-Media Program 42, the Object insertion process is more complex than a simple Object 32 substitution. In this case, the selected Object 32 together with the background layer of multimedia content juxtaposed to the Multi-Media Object Location 21 needs to optimally have the background multimedia layer morph (and foreground morph, if necessary), modify, or adjust its shape to match the new shape and size and motion of the Multi-Media Object Location 21 so that the new Object 32 is now contiguous in its placement into the Master Program 11. It is also possible to morph, modify, or adjust the shape and size of the Object 32 but this is disadvantageous since most Objects 32 have identifiable shapes, colors, sizes etc., that confer brand recognition; thus, morphing the Object 32 could impair the value of the dynamically placed in situ Object 32 (product placement). This is particularly true for an Object 32 in motion (likewise for a Multi-Media Object Location 21 that is in motion). The preferred embodiment is to morph, modify, or adjust the background (or foreground) in synchronization with the Multi-Media Object Location 21 versus doing a likewise process on the Object 32. It is most desirable to match the new Object 32 with a new Multi-Media Object Location 21 so that these two elements are identical in shape (if a visual representation) with only the background (foreground) changing. Finally, if an Object 32 has two dimensions, video and audio, the Object's audio would be mixed with the Master Program audio to create a seamless audio stream for the life of the Object 32.

### Multi-Media Object Insertion—Interactivity with Surroundings in a Multi-Media Program

In the case where the selected Object 32 is not identical in its “footprint” but also either interacts with surrounding visualizations, or must be interfaced with surrounding subjects in the program, the Object insertion process requires manipulation of the selected Multi-Media Object Location 21 and the Master Program 11 background juxtaposed to the Multi-Media Object Location 21, to ensure the nature of the selected Object 32 is not changed, and the juxtaposed surroundings are naturally morphed, modified, or adjusted to ensure the interface between the selected Object 32 and the juxtaposed multimedia background or interrelated visualizations are harmonious in a seamless fashion. Thus, where a hand is holding a beverage container and the selected Object 32 provides a representation of a beverage container of different shape, the hand must be modified so the hand with the beverage container of the selected Object 32 appears natural This can be done by electronically inserting a “new hand with the proper finger locations”, or it could be done by shooting a short clip new scene and then digitally inserting that new scene when the new Object 32 with a beverage container handle is used. Thus, the director and producer of the Master Program, including the writers or authors of the Master Program, could anticipate in advance the likely set of possible Object 32 shapes that would be used in the finished product Multi-Media Program 42, and where necessary, create additional movie segments (video and audio) that accommodate all the likely Object 32 shapes and motions.

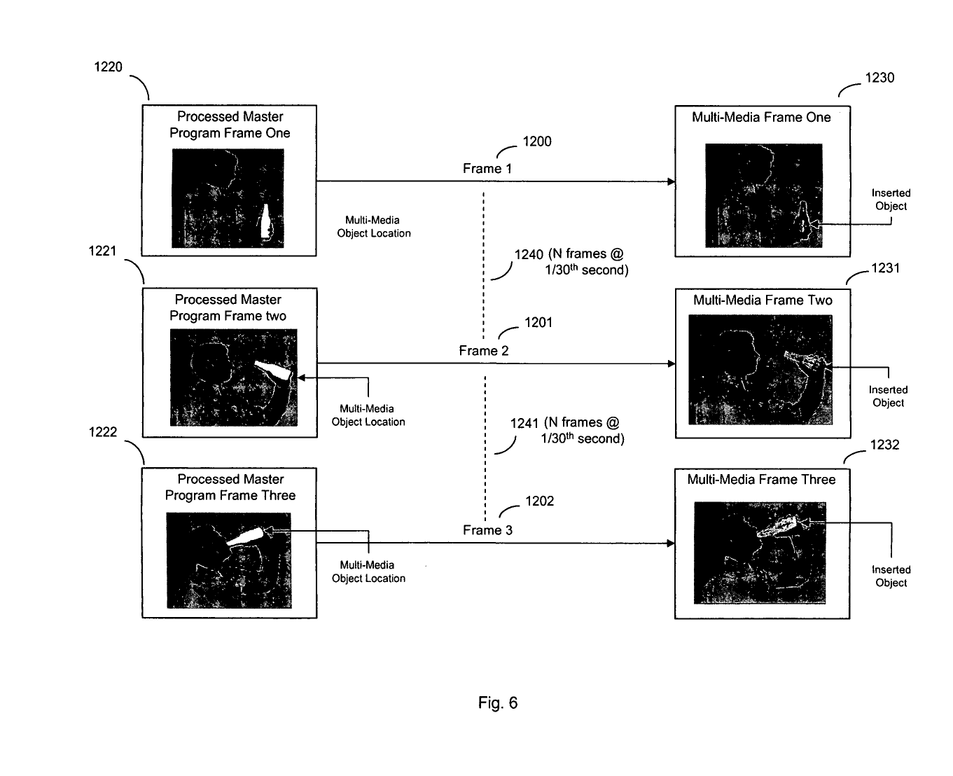

FIG. 6 shows the creation of a Multi-Media Object Location 21 in the upper left hand corner which is in the shape of a bottle. The man consuming the beverage identified by this Multi-Media Object Location 21 is shown as a static image (non-changing); however, the invention does not limit the concept to embody this being a single frame or field of a movie or television program. In fact, the preceding and subsequent frames would likely have the Multi-Media Object Location 21 in motion.

### System Architecture—Localized Object Insertion

FIGS. 3C and 3D illustrate, in block diagram form, two overall architectures of the multi-media object management system using a localized recipient based Object insertion paradigm. Recipient Location Object Insertion has the finest granularity and accuracy of Object delivery based on the profile of a given Recipient. This architecture is also the most expensive to replicate since the Object insertion technology must reside at every recipient's location, whether it is a cell phone, a PDA, an HDTV, a radio, or an iPod. It is also conceivable that the composite architecture of a given system could involve elements of the central scheme, the regional scheme, and the local scheme.

Emerging video or television architectures that use IPTV (Internet Protocol Television) are also a form of local delivery and could be delivered to a personal computer or to an IPTV set-top box. One advantage that IPTV has is that the Recipient Database (shown in FIG. 1 as 33 and also in FIG. 3C as 160-1) is generally available (physical location, what person is using which device, demographics, psychographics, socio-graphics, viewing habits, and so on).

If the device is a mobile one, such as a cell phone enabled for video reception in some manner, GPS location is known as well as the subscriber database is stored in database registers such as HLRs (Home Location Registers) and VLRs (Visitor Location Registers). Thus, in the mobile context, Recipient Database 33 information is inherently and automatically available enabling optimal Object selection and insertion. In this mobile example, the Recipient Database 160-1 in FIG. 3C (in cellular an HLR or VLR) feeds this Recipient information into the Object Insertion Processor 150-1 (also FIG. 3C) to optimize Object 32 insertion into the video being watched by a mobile handheld device subscriber.

The localized recipient object insertion architecture truly matches Objects 32 with Recipient's interests, needs, and desires contained in Recipient Database 33. In this context, the advertiser has made an optimal connection with the recipient for a given product or service which is imbedded into the content stream. Break and Make advertising is no longer required, and a 30-minute Multi-Media Program is truly 30 minutes of entertainment. In the era of e-books or e-readers, the Recipient downloads a magazine and has electronic advertising that is directly paired with that Recipient's interests. Object 32 definition could even include, for example, the favorite color of the Recipient (say for an advertised car the Recipient is interested in). For all of these architectures, but in particular for the Local Insertion which is highly customized, a third database, shown in FIGS. 3C and 3D, the Recipient Database 160-1 to 160-P, stores the demographic, psychographic, and socio-demographic profile of all recipients. This Recipient Database 160-1 to 160-P is constantly evolving, ever matching the changing desires, needs, and wants of the Recipient. For instance, if the Recipient gets married and has children, Objects may need to be more family oriented. As the Recipient becomes an empty nester, Objects may become more travel oriented, for example, with life experiences being a central focus.

In FIGS. 3C and 3D, Objects are stored in an Object Source 102 and Object Ready Content 23 is stored as data files in a Content Source 101. The content stored in the Content Source 101 contains graphical, visual, and aural information plus Object centric information. Both Objects 32 and content are retrieved from their respective repositories 102, 101 and transmitted via distribution network 120 in FIG. 3C and across networks 140 and 141 in FIG. 3D via distribution networks 120-1, 120-2 to a plurality of Object Insertion Processors 150-1 to 150-N, which are located proximate to the Recipients 130-1 to 130-N. The Object Ready Content and the Objects are merged into a single data stream by the Object Insertion Processors 150-1 to 150-N. The deployment cost of a localized system is greater than other architectures since it replicates the Object Insertion Processors 150-1 to 150-N and also maintains one or more Recipient Databases 160-1 to 160-N.

FIG. 3D shows the Object Ready Content being distributed by network 120-1 and the Objects are distributed via a separate network logical or physical, labeled 120-2. FIG. 3D illustrates the case where the Object Source 102 is served by a network 120-2 that is different than the network 120-1 that serves the Content Source 101. In fact, there can be multiple content sources and multiple Object 32 sources, served by different or the same networks, such that the Object Ready Content 23 and the appropriate Objects 32 are retrieved from their repositories, wherever they may reside, by the Object Insertion Processors 150-1 to 150-P and combined therein for the corresponding recipient.

### Object Insertion Processor

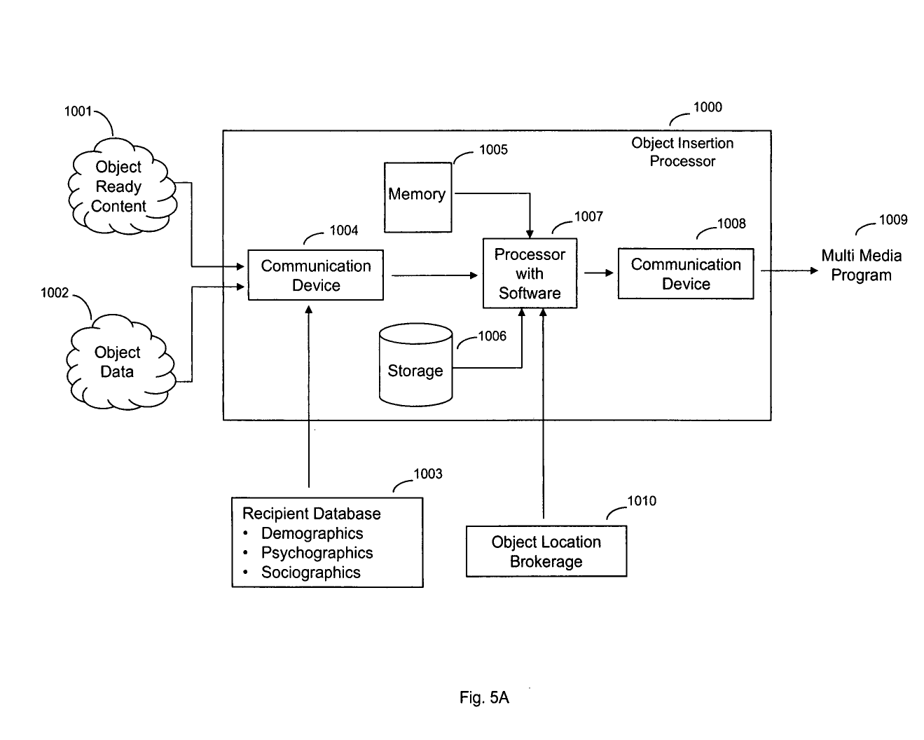

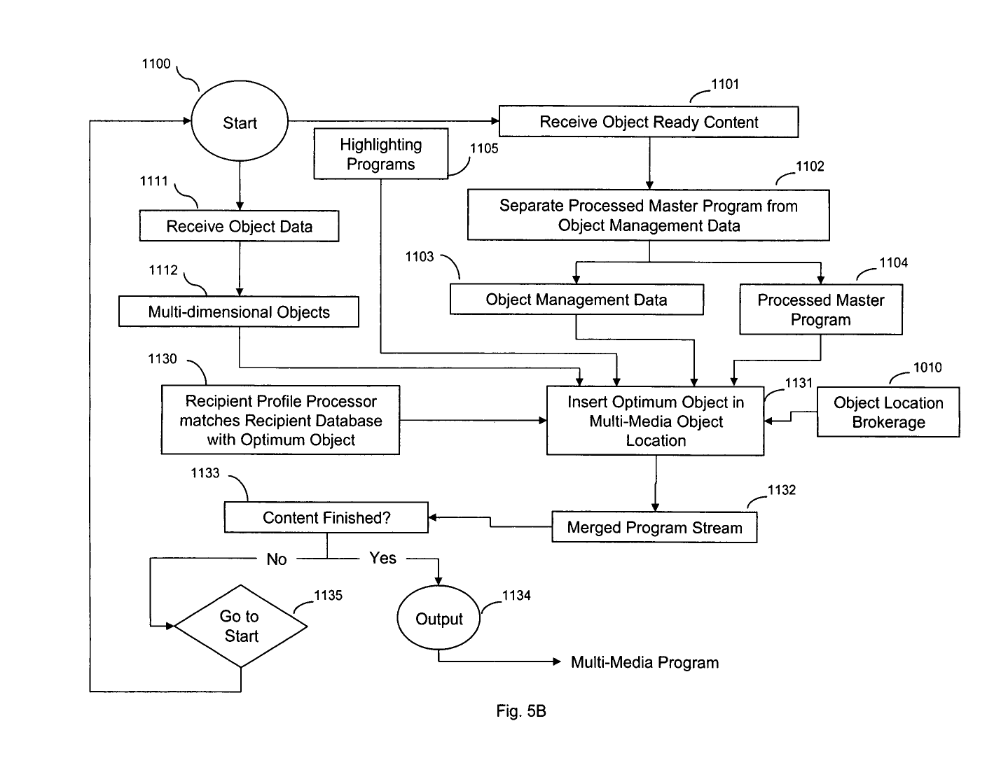

FIG. 5A illustrates, in block diagram form, the overall architecture of a typical Object Insertion Processor, and FIG. 5B illustrates, in flow diagram form, the operation of a typical Object Insertion Processor, on a frame-wise basis in inserting Objects into Multi-Media Object Locations. The Object Insertion Processor 1000 is the hardware-software enabled device which does the Object insertion into a given Object Ready Content stream. For example, if the Object Ready Content 23 is a movie, the Object Ready Content 23 has a plurality of Multi-Media Object Locations 21 in both the audio and video where Objects 32 are to be inserted, as well as Object Management Data 22 that defines the characteristics of the Multi-Media Object Location 21 as noted above. The Object Data 1002 contains the representation of the Object to be inserted at a given location and time and space in the content data stream, as well as Object Characteristic Data 31 that defines the essential attributes of the Object 32.

The Object Insertion Processor 1000 shown in FIG. 5A also receives data from a Recipient Database 1003 (shown also as 33 in FIG. 1) such as demographics and psychographics, socio-profile, and viewing habits for a given Recipient (where the Recipient Database 1003 is ever changing) and pairs that information with the entire Set of Objects to select the “best” Object 32 to be inserted (i.e., a Pepsi® drinker isn't interested in seeing a Coke® ad or Coke® wishes to steal market share from Pepsi® and advertises it's Objects to Pepsi® drinkers who are on the “decision fence”). The output of the Object Insertion Processor 1000 is Multi-Media Program (Customized Object Content) 1009 that is Recipient optimized from an Object 32 insertion paradigm.

Object Insertion Processor 1000 performs additional tasks such as high reliability and high availability communications at devices 1004 and 1008, the input and output nodes, respectively, of Object Insertion Processor 1000. The Object Insertion Processor 1000 has Memory 1005 and Storage 1006 to manage data flow and processing capability in 1007. In addition, the Highlighting Programs, as described below, are stored in Memory 1005 for use in generating Highlighted Objects.

More complex, the Object Insertion Processor 1000 performs tasks at 1007 such as morphing a given video frame so that the inserted Object fits fully into the “content hole” (also termed Multi-Media Object Location 21)—this process is essential since an inserted Object 1 to inserted Object N in the matrix of possible Objects available to insert may not have the same exact shape (i.e., a Heineken® bottle has a different shape than a Coors® bottle). This morphing process continues for every frame until the Object insertion timeframe is completed; and a given frame could have 1 to Y Objects being inserted in a concurrent or simultaneous fashion, with any given frame having its own defined set of Objects being inserted.

For a video data file, the Objects contained therein are generally two-dimensional—an image and associated sound clip (to be merged into the composite audio stream). However, there is no limitation on Objects being in only two dimensions. Objects are multi-dimensional (to include visual effects to create a 3-D perspective from the Recipient's viewpoint) and necessarily have attributes associated with those dimensions. Attributes such as feel, smell, taste, and others are readily possible. The Highlighting of an Object can also take on multiple dimensions such as visual, aural, smell, and touch—in any and all combinations. Objects can also have Highlighted spatial attributes such as 2-D or 3-D. Highlighted Objects can be highlighted in a manner to draw attention to the Object through a variety of methods to include some form of juxtaposition with respect to the Master Program.

The Object Insertion Processor Algorithm starts at step 1100 with the receipt of the Objects 1111 and the Object Ready Content data 1101. The Object Ready Content data 1101 is further separated at step 1102 into the Object Management Data 1103 and the processed Master Program 1104. The Objects 1111 are multi-dimensional, and the Object Database of Objects 1111 can contain exactly the exact number of needed Objects, or it could contain the entire universe of available Objects 1111 (from which it has to make a selection based on the Recipient Profile Processor 1130 using the Recipient Database 33). The Object is inserted into the content “hole” (or Multi-Media Object Location) at step 1131 as a function of the purchase of the Multi-Media Object Location, as identified by the Object Location Brokerage 1010, in a continuous fashion where step 1132 is a frame or field of a composite video stream (for example) until the content stream is complete as determined at step 1133. The Object Insertion Processor Algorithm process can be done in advance, near real time, real time, or just-in-time. The timing of when an Object 32 and 1111 is inserted affects the market value of an Object.

### Object Selection Process

The population of the Multi-Media Object Locations 21 with Objects 32 is controlled not only by the appropriateness of the Object 32 in the Master Program 11 but also by the purchasing of the Multi-Media Object Locations 21 by advertisers to have their products displayed in the Multi-Media Program 42. Likewise, a purchased Multi-Media Object Location could involve Highlighting the Object where such Highlighting may be considered to be a “premium” service to the advertiser and would have a corresponding additional cost. Objects can be Highlighted at the central, regional, local, or recipient level. This highlighting may occur at all levels depending on the “highlighting buy decision” of a given advertiser—there is nothing to limit an advertiser from highlighting a given object at the national level and then, re-inserting a new highlight for a given object for a specific household. Here too, the additional premium for Highlighting is dependent on where the Highlighting occurs. There are numerous procedures that can be used to effect the purchase and management of the Multi-Media Object Locations 21 and Highlighting, and these result in the creation of a set of attribution data that defines the particular Object 32 that is to be used to populate a selected Multi-Media Object Location 21, subject to the Master Program Rule Set 12, the Object Characteristic Data 31, and the Object Management Data 22 confirming the selection.

The Object Insertion Processor (for example, 110 in the Central Architecture 3A) must select an appropriate Object 32 for insertion into a selected Multi-Media Object Location 21 based upon certain parameters that are defined in the Object Management Data 22 and the Object Characteristic Data 31. In addition, the purchasing of selected Multi-Media Object Location 21 by advertisers is a consideration and must be reconciled with the parameters that are defined in the Object Management Data 22 and the Object Characteristic Data 31. For example, the Object Insertion Processor 110 as shown in FIG. 3A determines the nature of the Object 32 from the Object Management Data 22 and thereby can identify a class of Objects 32 from the Object Characteristic Data 31 that would be appropriate to use in populating this selected Multi-Media Object Location 21. The members of this class are then available for selection by advertisers, subject to any associated limitations provided by the Master Program Rule Set 12.

If an Object 32 is determined to violate one of the rules in the Master Program Rule Set 12 or Object Management Data 22, or there is a failure to match Object 32 with the selected Multi-Media Object Location 21 due to the Object Characteristic Data 31 failing to match the Object Management Data 22, the Reconcile Processor 52 includes a process to terminate the Object insertion into the selected Multi-Media Object Location 21. The Reconcile Processor 52 can then generate an error indication to a system operator or can autonomously locate a substitute Object for insertion into the selected Multi-Media Object location 21 by retrieving a default Object that is in this class of Object, an Object that represents the Object that was next highest in the bidding process for this Multi-Media Object Location, or some other Object owned by the same purchaser that is appropriate for the selected Multi-Media Object Location. There are numerous options that can be envisioned for managing this situation, and these mentioned above represent typical responses.

### Examples of Multi-Media Object Population of Multi-Media Object Locations

FIG. 6 illustrates three frames 1220-1222 of a Multi-Media Program and a representation of each frame using a selected Object to populate the Multi-Media Object Location. In particular, FIG. 6 illustrates a subject holding a “blank” beverage container to drink from the beverage container (shown in white or clear space which is the Multi-Media Object Location). In FIG. 6, the beverage container is a Multi-Media Object Location, and its extent in this frame of the Multi-Media Program is delineated by the “white” area in the image. As can be seen from this image, the full extent of the beverage container is obscured in part by the subject's hand in holding the beverage container, where such obscuration is often typical of a Multi-Media Object Location.

Any number of Objects can be selected to populate this Multi-Media Object Location, and the example illustrated herein in FIG. 6 is illustrative of a typical product that can be used to populate the Multi-Media Object Location. These Object insertions can occur on a centralized, regional, or local basis, so the same image, personalized by the insertion of a selected Object (product), can be delivered to various groups of recipients or individual recipients as described below. It is also necessary in the use of an Object to populate a Multi-Media Object Location to adapt the Object to correspond to the extent of the Multi-Media Object Location. Thus, a “stock” Object may have to be dynamically modified to account for the subject's hand shown in the frame, the size of the Object may have to be proportionately adjusted to be consistent with the location in the frame (foreground, background, perspective view, etc.), and the boundary between the Object as inserted into the selected Multi-Media Object Location may have to be “morphed”. Alternatively, the “background” layer “behind” and “in front of” the Object can also be “morphed” to wraparound or fit into the inserted Object should the Multi-Media Object Location be different than that of the selected Object. This background and foreground modification can be accomplished by using predictive algorithms well known in the art. In addition, the characteristics of the Object may be adjusted, using well-known image processing techniques, so the representation of the Object, in terms of hue, saturation, color, brightness, etc., are consistent with the surroundings in the frame. In addition, algorithms and methods are readily available to insert “synthesized” bits into the digital data stream to “fill” the region between an Object and the Master Program based on contextual information such as what color is the pixel pre- and post- the Object location.

### Highlighting a Selected Object

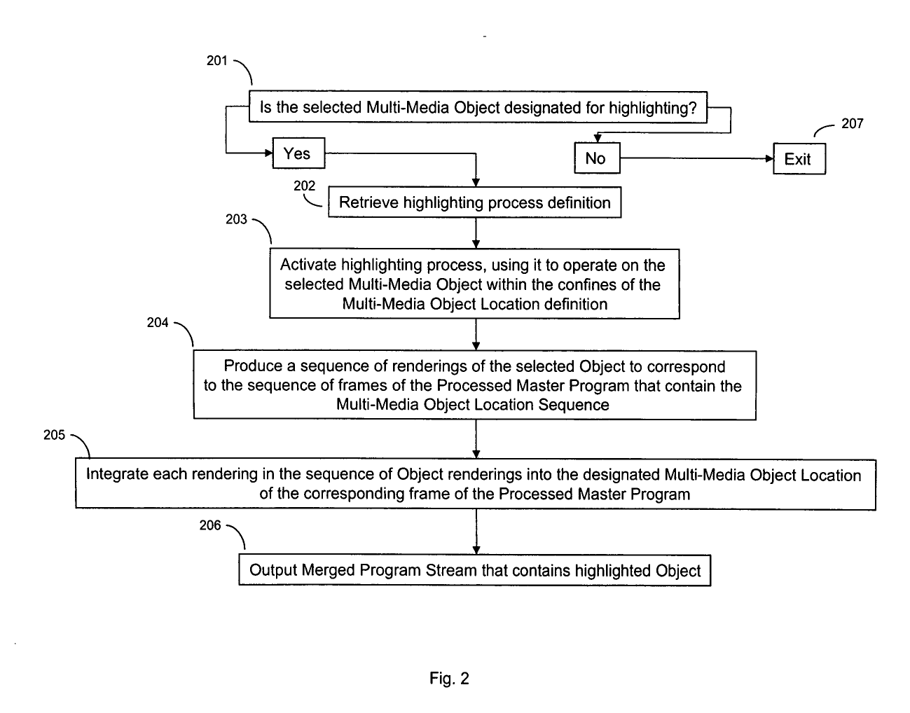

FIG. 2 illustrates, in block diagram form, the operation of the multi-media object highlighting system in generating a highlighted representation of the selected Object. The selection of an Object to populate a Multi-Media Object Location in a Multi-Media Program occurs as described herein. In addition to selecting the Object, the representation of the selected Object can be specified in terms of highlighting to emphasize the Object when it is integrated into the Multi-Media Program and the Multi-Media Program is run to generate the visualization to the user. The highlighting process depicted in FIG. 2 can be conducted in a time concurrent fashion wherein more than one object is highlighted at the same time or in overlapping timeframes. For example, in the frames of a program, a bride's wedding ring could be highlighted while the groom's wedding ring is also highlighted at the same time as they drive by a highlighted billboard featuring DeBeer's diamonds (in their wedding limo). Thus, there is nothing to limit the number of object highlighted or the type of highlighting of these objects in any given frame or sequence of frames. And, as described herein, this highlighting can be multidimensional (visual, aural, sense, taste, smell) and the highlighting of a given object may change their respective sensory emphasis from one frame to the next of an object highlighting sequence (i.e. for a given object's sequence of frames of highlighting, the object may initially be highlighted using a visual form and then conclude the object frame sequence with an aural form of highlighting).

As illustrated in FIG. 5B, the Object Insertion Process 1131 takes a selected Object from the set of Multi-Dimensional Objects 1112 and implements the rules provided by the Object Management Data 1103 to integrate the selected Object into the designated Multi-Media Object Location in the Processed Master Program 1104 to create the Merged Program Stream 1132. In step 201 in FIG. 2, the Object Insertion Process 1131 determines whether the selected Multi-Media Object should be designated for highlighting. If not, the object highlighting process is not activated. If the selected Multi-Media Object is designated for highlighting, processing advances to step 202 where the Object Insertion Process 1131 retrieves, from Memory 1105 (labeled Highlighting Programs in FIG. 5B), the highlighting process definition that has been selected to create the highlighting effects for the selected Object. At step 203, the Object Insertion Process 1131 activates the highlighting process definition, using it to operate on the selected Multi-Media Object within the confines of the Multi-Media Object Location definition. In particular, the Object Insertion Process 1131 must determine the number of frames of the Processed Master Program that contain this Multi-Media Object Location Sequence in order to produce a sufficient number of representations of the selected Object to convey the highlighting effect. Thus, Highlighting is on a frame-by-frame or field-by-field basis for a given Highlighting Sequence duration. During this temporal and spatial Highlighting process, the subsequent frame's Highlighting may be different than the Highlighting of the preceding frame and the scan, for example, could be interlaced or progressive. Therefore, at step 204, the Object Insertion Process 1131 produces a sequence of representations of the selected Object which may or may not be Highlighted to correspond to the sequence of frames of the Processed Master Program that contain the Multi-Media Object Location Sequence. The Object Insertion Process 1131 at step 205 then integrates each representation in the sequence of Object representations into the designated Multi-Media Object Location of the corresponding frame of the Processed Master Program and at step 206 outputs the Merged Program Stream that can contain a mix of Highlighted Objects and regular Objects (alternatively, all Objects could be Highlighted).

The highlighting can be any of a number of representation effects that produce a human sensible visualization. These human sensible characteristics can be multi-dimensional and may include, but are not limited to: visual only, visual and aural, aural only, and 3-D representation, where the recipient possibly wears special glasses so that only the selected Highlighted Object is present in 3-D form (or have some other unique attribute which is “enabled” by wearing special glasses). The visual effects can include: flashing, changes in brightness, movement, change in representation, and the like. The highlighting can switch between selected highlighting effects or the selected highlighting effects may be concurrently operational, such as flashing and movement. The highlighting can also include the use of an anomaly, such as a color representation in a black and white multi-media program or a black and white representation in a color multi-media program, or even an out-of-context object, such as an object inappropriate for the time frame or context of the program content. With these characteristics, the time required to produce a human sensible effect must be determined in order to make the resultant highlighting effective yet not unduly intrusive to the program content. This is particularly true for senses that take “time to develop” and then “clear”, such as aromas and smell. Other senses, such as touch, can be more immediate in their implementation, such as a motion-enabled seat back. That said, not all touch senses are this immediate. For aural Highlighting, the sense of hearing is immediate and generally there is no lag or wait after the aural Highlighting is removed.

FIG. 6 illustrates a sequence of three frames of a Multi-Media Program and a representation of the sequence of frames using a selected Object to populate the Multi-Media Object Location shown in the sequence of three selected frames. The three images 1220-1222 represent a sequence of three frames 1200-1202 sampled at intervals 1241, 1242 from the stream of frames (generated at the traditional rate of 1/30 second for television and 1/24 second for movies) the display of a Processed Master Program, presented to the recipient as Multi-Media Program frames 1230-1232. Each image 1220-1222 of the Processed Master Program includes a Multi-Media Object Location, which in this instance is a beverage container. The subject in this sequence of frames is lifting the beverage container to their lips to drink from the beverage container. The Multi-Media Object Locations in these three frames represent a set of Multi-Media Object Locations and are managed uniformly, in that the same Object is used to populate the three frames (and the intervening frames) since there is a consistency of theme in this sequence of frames. Thus, as can be seen from FIG. 6, the Multi-Media Object Location in each of the frames 1220-1222 of the Processed Master Program have been populated with an Object comprising a representation of a particular brand of beverage container, resulting in the three frames of the Multi-Media Program 1230-1232 including the inserted Object as if it were in the original rendition of the Master Program 11. An advertiser would, in this example, purchase the Multi-Media Object Location in all of the video (movie) frames that are in the sequence where the Object is present, thereby forming a “Set” of Multi-Media Object Locations.

In order to highlight the selected Object, one or more of the object highlighting paradigms can be activated to draw the recipient's attention to the selected Highlighted Object. For example, the brightness of the Object as displayed can be varied to “blink” the Object as the sequence of frames is displayed. Thus, the first frame 1230 illustrated in FIG. 6 may contain the standard representation of the selected Object, then successive frames of the Processed Master Program contain representations of the selected Object that are in ever increasing intensity (or luminance) so the second frame 1231 illustrated in FIG. 6 is, for example, set to be at one-half the difference between the standard brightness level of the selected Object and a maximum brightness level, which is produced for the third frame 1232 illustrated in FIG. 6. As the Processed Master Program continues and the selected Object remains in view, the brightness level of the selected Object is reduced to the standard brightness level of the selected Object over a series of frames of the Processed Master Program. This cycle of change in brightness level can end at that juncture or may continue if the duration of the selected Object remaining in view is of sufficient duration. In fact, this example of luminance brightening of an Object could occur over tens of frames if the Object's duration is multiple seconds; in this case, to provide a smooth transition from Frame 1 to Frame N, the Highlighting algorithm would gradually transition the luminance or brightness over the entire Highlighting Sequence. The highlighting process definition is typically algorithmic in nature and represents a balance between effecting at least one cycle of the change in visualization of the selected Object and having the change in visualization be noticeable by the recipient. The parameters to define the appropriate algorithm are typically a function of the effect being implemented, with the blinking of an object having a different cycle than the movement of an object or the change in color or hue of the representation of the selected Object. Other highlighting effects are primarily static in nature, such as the use of an anomaly, such as a color representation in a black and white multi-media program or a black and white representation in a color multi-media program, or even an out-of-context object, such as an object inappropriate for the time frame of the program content. In addition, a combination of highlighting effects can be concurrently operational to heighten the effect of the highlighting. Thus, a black and white rendering in a color multi-media program can also be cycled through a change in brightness level or chroma (color change).

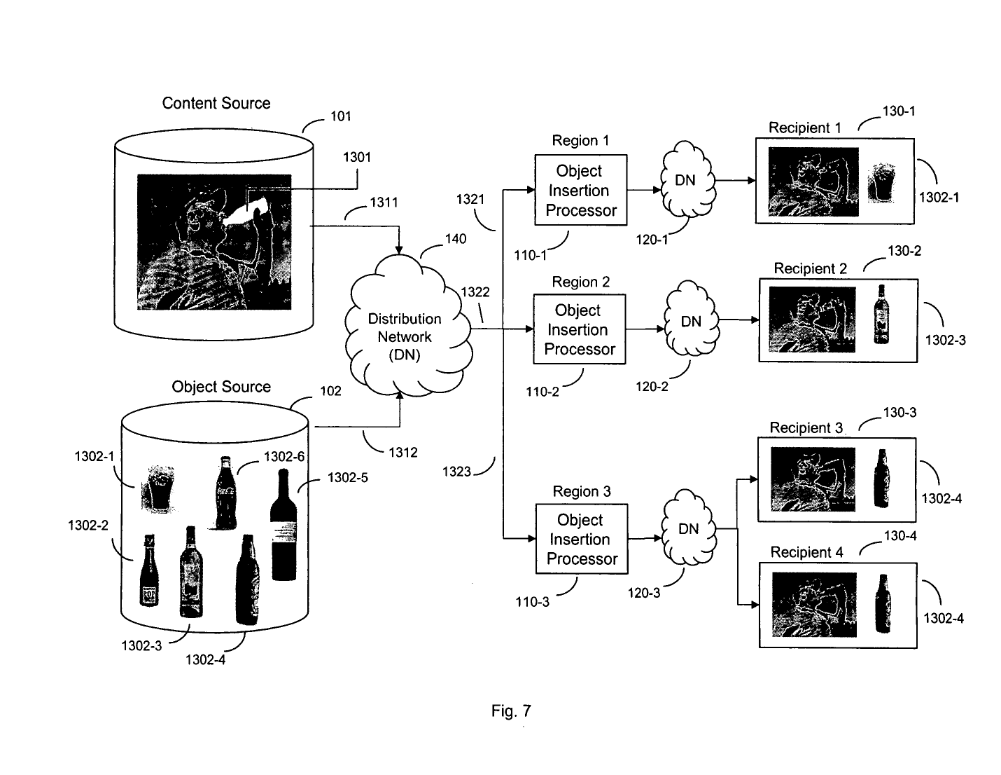

FIG. 7 illustrates the distribution of a single frame of a Multi-Media Program to multiple Recipients in multiple Regions with the Multi-Media Object Location in the frame being populated with different Objects for each Region. For example, while not graphically shown in FIG. 7, each region could have no highlighting; or some regions could have highlighting known to be particularly effective for that region, even as different regions receive different objects. In this instance, the Content Source 101 is delivering Object Ready Content via path 1311 to Distribution Network 140 and then via paths 1321-1323 to multiple Object Insertion Processors 110-1 to 110-3. Similarly, the Object Source 102 contains a plurality of Objects 1302-1 to 1302-6 that are of the same class as the Multi-Media Object Location 1301 illustrated in the image frame shown in FIG. 7. Each Object Insertion Processor 110-1 to 110-3 serves a particular Region (Regions 1-3) of the area served by the multi-media object highlighting system and can select any of the Objects 1302-1 to 1302-6 that are appropriate for populating the selected Multi-Media Object Location 1301, as defined by the purchase decision managed by the Object Location Brokerage 1010 (not shown on this Figure). Each Multi-Media Object Location purchase results in the associated Object Insertion Processor 110-1, for example, retrieving an Object 1302-1 from the Object Source 102 and using the retrieved Object 1302-1 to populate the selected Multi-Media Object Location 1301.

Thus, as can be seen from FIG. 7, while the Object Insertion Processor 110-1 selected Object 1302-1 to populate Multi-Media Object Location 1301 to create image 1302-1 for delivery via Distribution Network 120-1 to Recipient 130-1, the Object Insertion Processor 110-2 selected Object 1302-3 to populate Multi-Media Object Location 1301 to create image 1302-3 for delivery via Distribution Network 120-2 to Recipient 130-2, and the Object Insertion Processor 110-3 selected Object 1302-4 to populate Multi-Media Object Location 1301 to create image 1302-4 for delivery via Distribution Network 120-3 to Recipients 130-3 and 130-4, resulting in three different representations of the same frame of the Multi-Media Program appearing in the three different Regions, delivered to four different Recipients. The highlighting algorithm for three different Regions, delivered to four different Recipients, and likewise would be accordingly unique.

### SUMMARY

The present multi-media object highlighting system controls the retrieval of Object data that comprises an object representation (such as a product) and the integration of this Object data into a corresponding selected one of the predetermined Multi-Media Object Locations which are components of the Multi-Media Program. This enables advertisers to precisely control product placement on a customized basis thereby to dynamically modify the content of the Multi-Media Program as it is delivered to the individual recipient. The present multi-media object highlighting system takes the Master Program and creates the Multi-Media Object Locations with their associated Object Management Data thereby to enable the system to populate these Multi-Media Object Locations with appropriate Objects which are selected on the basis of purchaser interest, appropriateness for the selected Multi-Media Object Location, as well as the interests of the Recipients. In addition, the multi-media object highlighting system produces a representation of the Object that highlights the Object in the scenes in which it appears. The highlighting can be any human sensible characteristic, such as, but not limited to: flashing, changes in brightness, movement, change in representation, and the like. The highlighting can also include the use of an anomaly, such as a color representation in a black and white multi-media program or vice versa, or out-of-context object. Thus, the present multi-media object highlighting system provides an adaptable yet dynamic service for the placement of objects into a Multi-Media Program, with the end product containing Object representations that are integral to the Multi-Media Program.

What is claimed as new and desired to be protected by Letters Patent of the United States is:

1. A multi-media object highlighting system, responsive to receipt of a Master Program that contains at least one multi-media object location, for dynamically inserting an object into a corresponding multi-media object location to produce a multi-media program, comprising:
object reconciliation means for selecting an object to populate said selected multi-media object location,
object placement means for dynamically integrating said selected object into said selected multi-media object location to produce said multi-media program, and
object highlighting means for modifying the representation of said selected object that is integrated into said selected multi-media object location to produce a human sensible highlight of said selected object.

2. The multi-media object highlighting system of claim 1 wherein said object highlighting means comprises:
object representation definition means for storing data that defines at least one highlighting modification of said representation of said selected object.

3. The multi-media object highlighting system of claim 2 wherein said Master Program contains a Multi-Media Object Location Sequence comprising a plurality of successive frames of said Master Program in which the Multi-Media Object Location appears, said object highlighting means further comprises:
object highlight representation means, responsive to the number of frames of said Master Program that contain this Multi-Media Object Location Sequence, for producing a sequence of representations of the selected object that constitute highlighting modifications to said representation of said selected object pursuant to one of said at least one highlighting modification to correspond to the sequence of frames of said Master Program that contain the Multi-Media Object Location Sequence.

4. The multi-media object highlighting system of claim 3 wherein said object highlighting means further comprises:
Highlighted Object integration means for integrating each representation in the sequence of object representations into the designated Multi-Media Object Location of the corresponding frame of the Processed Master Program.

5. The multi-media object highlighting system of claim 2 wherein said Master Program contains a Multi-Media Object Location Sequence comprising a plurality of successive frames of said Master Program in which the Multi-Media Object Location appears, said object highlighting means further comprises:
object highlight representation means, responsive to the number of frames of said Master Program that contain this Multi-Media Object Location Sequence, for producing a sequence of representations of the selected object that constitute highlighting modifications to said representation of said selected object pursuant to a sequence of more than one of said at least one highlighting modification to correspond to the sequence of frames of said Master Program that contain the Multi-Media Object Location Sequence.

6. The multi-media object highlighting system of claim 2 wherein said Master Program contains a Multi-Media Object Location Sequence comprising a plurality of successive frames of said Master Program in which the Multi-Media Object Location appears, said object highlighting means further comprises:
object highlight representation means, responsive to the number of frames of said Master Program that contain this Multi-Media Object Location Sequence, for producing a sequence of representations of the selected object that constitute highlighting modifications to said representation of said selected object pursuant to more than one of said at least one highlighting modification to correspond to the sequence of frames of said Master Program that contain the Multi-Media Object Location Sequence.

7. The multi-media object highlighting system of claim 1 wherein said human sensible highlight of said selected object includes, but is not limited to: visual only, visual and aural, aural only, 3-D representation, smell, taste, and touch.

8. The multi-media object highlighting system of claim 7 wherein said visual human sensible highlight of said selected object includes, but is not limited to: flashing, changes in brightness, movement, and change in representation.

9. The multi-media object highlighting system of claim 3 wherein said object highlight representation means concurrently applies two or more human sensible highlights to said selected object.

10. The multi-media object highlighting system of claim 3 wherein said object highlight representation means switches among two or more human sensible highlights to said selected object.

11. The multi-media object highlighting system of claim 1 wherein said human sensible highlight of said selected object comprises the use of an anomaly.

12. The multi-media object highlighting system of claim 9 wherein said anomaly includes one of a color representation in a black and white multi-media program, a black and white representation in a color multi-media program, and an out-of-context object.

13. The multi-media object highlighting system of claim 1 wherein said human sensible highlight of said selected object comprises the use of a juxtaposition.

14. A method of highlighting object placement, in response to receipt of a Master Program that contains at least one multi-media object location, for dynamically inserting an object into a corresponding multi-media object location to produce a multi-media program, comprising:
selecting an object to populate said selected multi-media object location,
dynamically integrating said selected object into said selected multi-media object location to produce said multi-media program, and
modifying a representation of said selected object in said selected multi-media object location to produce a human sensible highlight of said selected object.

15. The method of highlighting object placement of claim 14 wherein said step of modifying a representation of said selected object comprises:
storing data that defines at least one highlighting modification of said representation of said selected object.

16. The method of highlighting object placement of claim 15 wherein said Master Program contains a Multi-Media Object Location Sequence comprising a plurality of successive frames of said Master Program in which the Multi-Media Object Location appears, said step of modifying a representation of said selected object further comprises:
producing, in response to the number of frames of said Master Program that contain this Multi-Media Object Location Sequence, a sequence of representations of the selected object that constitute highlighting modifications to said representation of said selected object pursuant to one of said at least one highlighting modification to correspond to the sequence of frames of said Master Program that contain the Multi-Media Object Location Sequence.

17. The method of highlighting object placement of claim 16 wherein said step of modifying a representation of said selected object further comprises:
integrating each representation in the sequence of object renderings into the designated Multi-Media Object Location of the corresponding frame of the Processed Master Program

18. The method of object highlighting placement of claim 15 wherein said Master Program contains a Multi-Media Object Location Sequence comprising a plurality of successive frames of said Master Program in which the Multi-Media Object Location appears, said step of object highlighting further comprises:
producing, in response to the number of frames of said Master Program that contain this Multi-Media Object Location Sequence, a sequence of representations of the selected object that constitute highlighting modifications to said representation of said selected object pursuant to a sequence of more than one of said at least one highlighting modification to correspond to the sequence of frames of said Master Program that contain the Multi-Media Object Location Sequence.

19. The method of object highlighting placement of claim 15 wherein said Master Program contains a Multi-Media Object Location Sequence comprising a plurality of successive frames of said Master Program in which the Multi-Media Object Location appears, said step of object highlighting further comprises:
producing, in response to the number of frames of said Master Program that contain this Multi-Media Object Location Sequence, a sequence of representations of the selected object that constitute highlighting modifications to said representation of said selected object pursuant to more than one of said at least one highlighting modification to correspond to the sequence of frames of said Master Program that contain the Multi-Media Object Location Sequence.

20. The multi-media object highlighting system of claim 17 wherein said human sensible highlight of said selected object includes, but is not limited to: visual only, visual and aural, aural only, 3-D representation, smell, taste, and touch.

21. The method of highlighting object placement of claim 20 wherein said visual human sensible highlight of said selected object includes, but is not limited to: flashing, changes in brightness, movement, and change in representation.

22. The multi-media object highlighting system of claim 16 wherein said step of object highlight representation concurrently applies two or more human sensible highlights to said selected object.

23. The multi-media object highlighting system of claim 16 wherein said step of object highlight representation switches among two or more human sensible highlights to said selected object.

24. The method of highlighting object placement of claim 14 wherein said human sensible highlight of said selected object comprises the use of an anomaly.

25. The method of highlighting object placement of claim 24 wherein said anomaly includes one of a color representation in a black and white multi-media program, a black and white representation in a color multi-media program, and an out-of-context object.

26. The multi-media object highlighting system of claim 14 wherein said human sensible highlight of said selected object comprises the use of a juxtaposition.
